(19) United States
(12) Patent Application Publication
(10) Pub. No.: US 2005/0289284 A1
(43) Pub. Date: Dec. 29, 2005

(54) High speed memory modules

(76) Inventor: Ge Chang, Folsom, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/877,588

(22) Filed: Jun. 24, 2004

(51) Int. Cl. G06F 12/00

(52) U.S. Cl. 711/1

(57) ABSTRACT

Apparatus and method for producing memory modules having a plurality of branches connected to a memory bus, each branch containing at least one dynamic random access memory (DRAM) device or synchronous random access memory (SDRAM) device connected to the memory bus via at least one transmission signal (TS) line and/or at least one sub-transmission signal (STS) line. The memory modules include at least one branch containing a resistor connected to the TS line or STS line and connected series with the DRAM device or SDRAM device and connected to the memory bus. A computing system implementing the memory modules is also discussed.

### FIELD

Memory modules

### BACKGROUND

Computing systems are comprised of a set of components that communicate with each other over buses and similar communication lines. Computing system components include processors, communication chipsets, memory modules, peripheral components and similar devices. These devices communicate with one another over a set of buses. These buses may utilize communication protocols understood by each of the components on the bus. Some components act as bus controllers to manage communication traffic on the bus.

Computing system speed and efficiency is limited by the speed of buses and communication lines in the computer system. A processor relies on a system bus, memory bus and memory controller for retrieving data and instructions from system memory. The processor is limited in the speed at which it can process these instructions by the speed at which it can receive the data and instructions over the system bus and memory bus from system memory.

Buses are typically communication lines laid out on a printed circuit board (PCB) such as the main board of a computing system. Components (e.g., memory) in the computing system have pins that connect to the lines of the bus. The components communicate across the bus by driving a signal across lines of the bus. These signals are latched by a recipient device. The signal is terminated by an on board termination circuit which includes a resistor or similar component. If a signal is not properly terminated, a reflection of the signal may occur or other noise may affect subsequent signaling on the line.

### BRIEF DESCRIPTION OF THE DRAWINGS

FIG. 1 is a block diagram of one embodiment of a memory module containing at least one resistor connected in series with a dynamic random access memory (DRAM) device and a memory bus.

FIG. 2 is a block diagram of a second embodiment of a memory module containing at least one resistor connected in series with a DRAM device and a memory bus.

FIG. 3 is a block diagram of a third embodiment of a memory module containing at least one resistor connected in series with a DRAM device and a memory bus.

FIG. 4 is a block diagram of one embodiment of a computing system containing the memory module of FIG. 2.

FIG. 5 is a flow diagram of one embodiment of a method to produce the memory modules of FIG. 1, FIG. 2 and FIG. 3.

### DETAILED DESCRIPTION

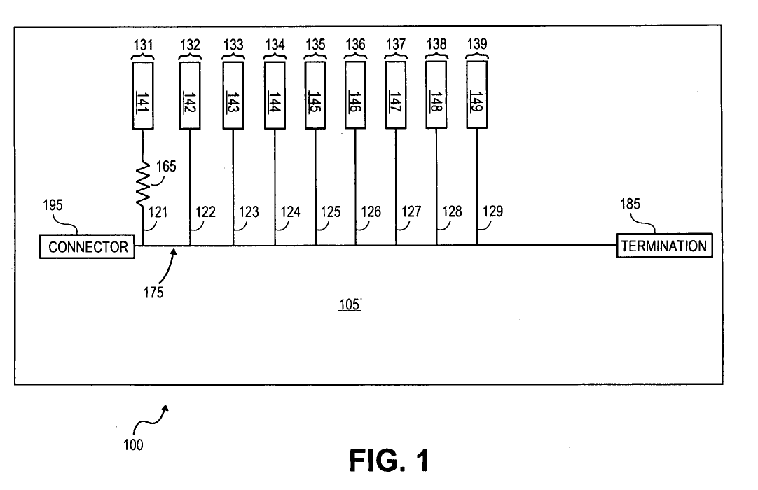

FIG. 1 is a block diagram of one embodiment of a memory module containing at least one resistor in series with a dynamic random access memory (DRAM) device and a memory bus. Memory module 100, in the embodiment shown in FIG. 1, is a single in-line memory module (SIMM).

In one embodiment, memory module 100 is formed on printed circuit board (PCB) 105. PCB 105 may be formed utilizing any method to form printed circuit boards or other types of circuit boards known in the art. In one embodiment, memory module 100 includes transmission signal (TS) lines 121 through 129 formed on PCB 105.

In the embodiment shown in FIG. 1, the pattern on PCB 105 includes memory bus 175 connected to TS lines 121 through 129. In other embodiments, memory module 100 may include any pattern for TS lines 121 through 129 and memory bus 175.

In one embodiment, TS lines 121 through 129 and memory bus 175 are formed of copper. In other embodiments, TS lines 121 through 129 and memory bus 175 may be formed of other conductive materials known in the art.

In one embodiment, memory bus 175 includes termination circuit 185 located after the attachment point of TS line 129 on memory bus 175 and opposite connector 195, which connects memory module 100 to other components of a computing system. In an embodiment, termination circuit 185 is connected to source to form a pull-up termination circuit. In another embodiment, termination circuit 185 is connected to ground to form a pull-down termination circuit.

Memory module 100, in one embodiment, includes DRAM devices 141 through 149. DRAM devices 141 through 149, in one embodiment, are each connected to a respective TS line, which, as discussed above, is also connected to memory bus 175 to form branches 131 through 139. DRAM devices 141 through 149 may each be any DRAM device known in the art capable of having data written to and read from it by a computing system. In the embodiment shown in FIG. 1, memory module 100 contains nine DRAM devices and branches, however, memory module 100 may contain any number of DRAM devices and branches.

In one embodiment, memory module 100 also includes resistor 165. Resistor 165, in an embodiment, is connected in series with DRAM device 141 on TS 121 and is connected to memory bus 175. Resistor 165, in one embodiment, is a 25 ohm resistor. In other embodiments, resistor 165 is a resistor in the range of about five ohms to about 150 ohms.

Memory module 100, in one embodiment, has a second resistor coupled to TS line 121 and in connected series between DRAM device 141 and memory bus 175. Likewise, this second resistor may have a resistance in the range of about five ohms to about 150 ohms.

In other embodiments, memory module 100 contains a plurality of resistors similar to resistor 165 connected in series with a respective DRAM device on a subset of TS lines and connected to memory bus 175. In this instance, a subset is one or more TS lines (e.g., TS lines 121, 122) having a resistor connected to each of the two TS lines and connected in series between the DRAM device (e.g., DRAM devices 141, 142) and memory bus 175. In one embodiment, the subset includes TS lines 121 through 129 each having at least one resistor similar to resistor 165 connected to it and connected in series with each of DRAM devices 141 through 149 to memory bus 175 to form a plurality of branches similar to branch 131. In one embodiment, the plurality of resistors are the same size. In other embodiments, at least two of the plurality of resistors are different sizes.

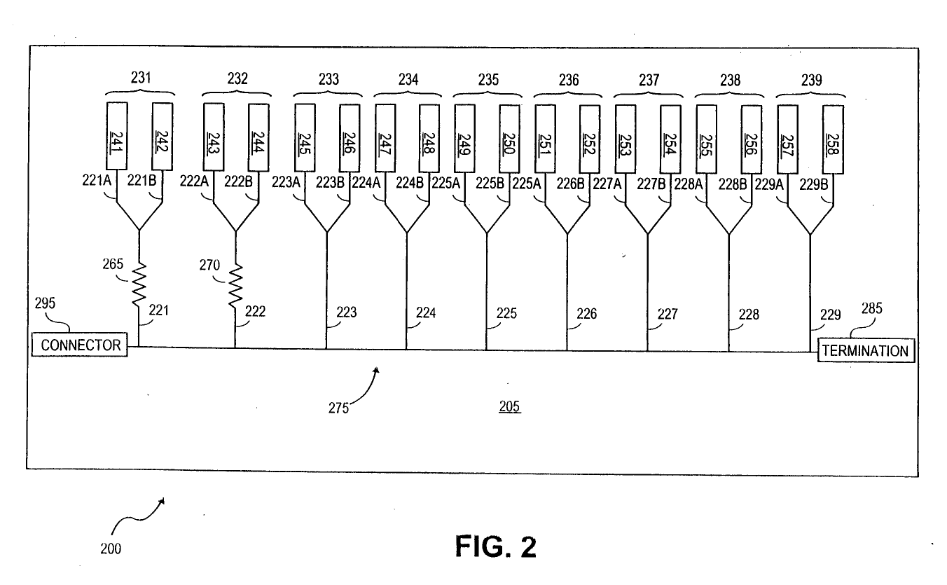

FIG. 2 is a block diagram of an embodiment of a memory module containing at least one resistor connected in series with at least one synchronous dynamic random access (SDRAM) device and connected to a memory bus. Memory module 200, in the embodiment shown in FIG. 2, is a double in-line memory module (DIMM).

In one embodiment, memory module 200 is formed on PCB 205 similar to the embodiments discussed above with regard to FIG. 1. Likewise, in one embodiment, memory module 200 includes TS lines 221 through 229 and memory bus 275, including termination circuit 285 and connector 295, on PCB 205.

Memory module 200, in one embodiment, includes SDRAM devices 241 through 258. SDRAM devices 241 through 258 may each be any SDRAM device known in the art capable of having data written to and read from it by a computing system. In other embodiments, SDRAM devices 241 through 258 may be replaced with DRAM devices similar to DRAM devices 141 through 149 discussed above. SDRAM devices 241 through 258, in one embodiment, are divided into pairs (e.g., SDRAM devices 241, 242; SDRAM devices 243, 244; etc.), and each pair is connected to one of TS lines 221 through 229, respectively, to form branches 231 through 239 consisting of two SDRAM devices and a single TS line.

In the embodiment shown in FIG. 2, memory module 200 contains 18 SDRAM devices forming nine branches, however, memory module 200 may contain any number of SDRAM devices and branches. In addition, in other embodiments, a branch may contain more than two SDRAM devices.

In one embodiment, memory module 200 also includes resistor 265 and resistor 270. Resistor 265, in an embodiment, is connected in series with SDRAM devices 241, 242 on TS line 221 and connected to memory bus 275. Similarly, in one embodiment, resistor 270 is connected in series with SDRAM devices 243, 244 on TS line 222 and connected to memory bus 275.

Resistors 265, 270, in one embodiment, are 25 ohm resistors. In other embodiments, resistors 265, 270 may be resistors in the range of about five ohms to about 150 ohms. In one embodiment, resistors 265, 270 are the same size. In other embodiments, resistors 265, 270 are different sizes.

In one embodiment, memory module 200 may have more than one resistor coupled to one or both of TS lines 221, 222 and connected in series with SDRAM devices 241, 242 and SDRAM devices 243, 244, respectively, and connected to memory bus 275. For example, TS line 221 may have two resistors connected in series with SDRAM devices 241, 242 on TS line 221 and connected to memory bus 275. Likewise, this second resistor may have a resistance in the range of about five ohms to about 150 ohms.

In other embodiments, memory module 200 contains a plurality of resistors similar to resistors 265, 270 connected in series with a pair of SDRAM devices on a subset of TS lines and connected to memory bus 275. A subset, in this regard, is one or more TS lines (e.g., TS line 221 and TS line 222) having at least one resistor connected in series with a pair of DRAM devices (e.g., SDRAM devices 241, 242 and SDRAM devices 243, 244) on each of the TS lines and connected to memory bus 275. Moreover, a subset, in one embodiment, includes each TS line (e.g., TS lines 221 through 229) having a resistor similar to resistors 265, 270 connected in series between each respective pair of SDRAM devices on each TS line and connected to memory bus 275 to form a plurality of branches similar to branches 231, 232. In one embodiment, the plurality of resistors are the same size. In other embodiments, at least two of the plurality of resistors are different sizes.

The embodiment shown in FIG. 2 shows a plurality of branches containing a resistor in the range of about five ohms to about 150 ohms connected in series with a pair of SDRAM devices on a TS line and connected to memory bus 275. In addition, memory module 200, in one embodiment, may have only one branch (e.g., branch 231) containing one or more resistors in the range of about five ohms to about 150 ohms connected in series with a pair of SDRAM devices (e.g., SDRAM devices 241, 242) on a TS line (e.g., TS line 221) and connected to memory bus 275.

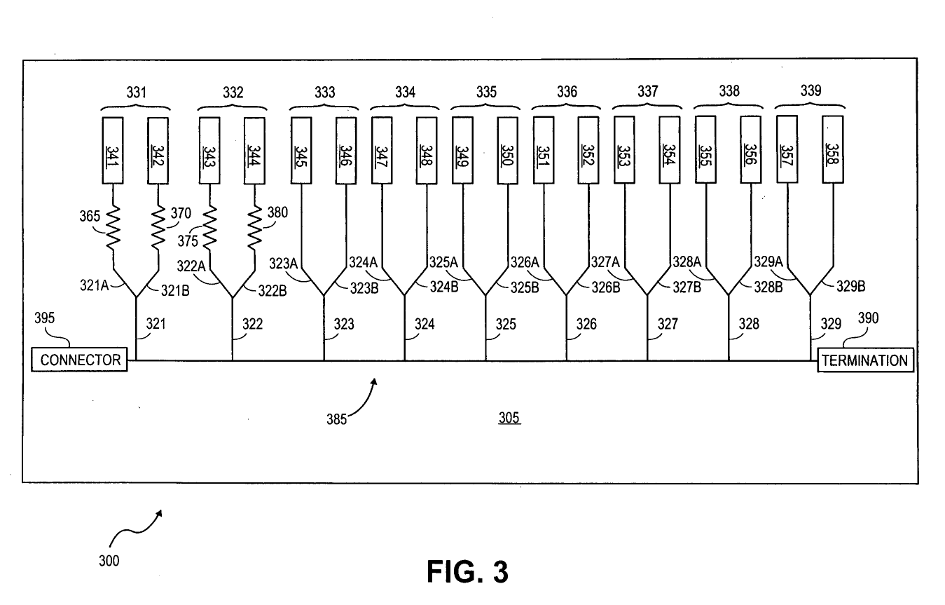

FIG. 3 shows a block diagram of another embodiment of a memory module containing at least one resistor connected in series between a SDRAM device and a memory bus. Memory module 300, in the embodiment shown in FIG. 3, is a DIMM including branches 331 through 339 (containing TS lines 321 through 329 connected to SDRAM devices 341 through 358, respectively) connected to memory bus 385, including termination circuit 390 and connector 395, similar to the embodiments discussed above with regard to FIG. 2.

In one embodiment, memory module 300 contains sub-transmission signal (STS) lines 321A, 321B through 329A, 329B connected to TS lines 321 through 329 and SDRAM devices 331 through 339, respectively. In the embodiment shown in FIG. 3, memory module 300 contains resistors 365, 370, 375, 380 similar to resistors 265, 270 discussed above, connected to STS lines 321A, 321B, 322A, 322B, respectively. In one embodiment, resistors 365, 370, 375, 380 are the same size. In other embodiments, at least two of resistors 365, 370, 375, 380 are different sizes.

In one embodiment, memory module 300 may have more than one resistor coupled to one or each of STS lines 321A, 321B, 322A, 322B and in series with SDRAM devices 341, 342 and SDRAM devices 343, 344, respectively, and memory bus 385. For example, STS line 221A may have two resistors connected to STS line 321A and in series with SDRAM device 341 and memory bus 275. Likewise, this second resistor may have a resistance in the range of about five ohms to about 150 ohms. In one embodiment, each resistor is the same size. In other embodiments, at least two resistors are different sizes.

In other embodiments, memory module 300 contains a plurality of resistors similar to resistors 365, 370, 375, 380 connected to a subset of STS lines within a single branch, each in series with a respective SDRAM device and connected to memory bus 385. A subset, in this regard, is at least one pair of STS lines (e.g., STS lines 321A, 321B and STS lines 322A, 322B) having at least one resistor connected to each of STS lines 321A, 321B, 322A, 322B, each resistor in series with a SDRAM device (e.g., DRAM devices 341, 342, 343, 344) and connected to memory bus 385. Moreover, a subset, in one embodiment, includes each STS line (e.g., STS lines 321A, 321B through 329A, 329B) having a resistor similar to resistors 365, 370, 375, 380 connected in series with each respective SDRAM device on the STS line and connected to memory bus 385 to form a plurality of branches similar to branches 331, 332. In one embodiment, the plurality of resistors are the same size. In other embodiments, at least two of the plurality of resistors are different sizes.

The embodiment shown in FIG. 3 shows a plurality of branches containing a resistor in the range of about five ohms to about 150 ohms connected in series with a SDRAM device on a STS line and connected to memory bus 385. In addition, memory module 300, in one embodiment, may have only one branch (e.g., branch 331) containing one or more resistors in the range of about five ohms to about 150 ohms connected to each STS line (e.g., STS lines 321A, 321B), each in series with a DRAM device (e.g., SDRAM devices 341, 342) and connected to memory bus 385.

In addition, in one embodiment, a single branch (e.g., branch 331) has only one resistor (e.g., resistor 370) located on one of the STS lines (e.g., STS line 321A) with the other STS line (e.g., STS 321B) does not have a resistor connected to it. In another embodiments, a subset of branches have only one resistor located on one of the STS lines while the other STS line is void of resistors.

It is contemplated that memory module 300 may have any combination of a plurality of resistors located on at least one STS line and at least one TS line, whether the STS line and TS line be within the same branch or on different branches. For example, in one embodiment, STS lines 321A, 321B each have at least one resistor connected to them and TS line 322 also has at least one resistor connected to it.

In addition, since “A” and “B” STS lines are in parallel, resistors 365, 370, for example, in one embodiment, are twice as large as, for example, resistor 265 discussed above to achieve a similar amount of resistance within branch 331 as contained with branch 221. This, likewise, applies to any pair of resistors connected in parallel on the STS lines discussed above.

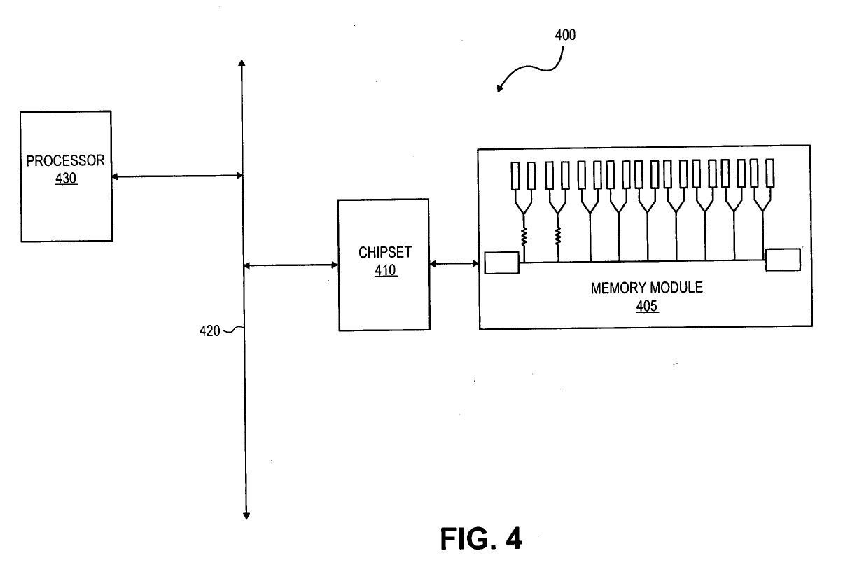

FIG. 4 is a block diagram of one embodiment of a computing system containing the memory module of FIG. 2. Computing system 400, in the embodiment shown in FIG. 4, contains memory module 405 similar to memory module 200 discussed above connected to chipset 410. In other embodiments, memory module 405 is similar to memory module 100 or memory module 300 discussed above.

Chipset 410 may be any communication hub known in the art capable of facilitating computing transactions. In one embodiment, chipset 410 is connected to system bus 420. System bus 420 may be any system bus known in the art capable of transmitting computing transactions.

In one embodiment, system bus 420 is connected to processor 430. Processor 430, in one embodiment, is a Pentium 4 processor manufactured by Intel Corporation of Santa Clara, Calif. In other embodiments, processor 430 may be any processor known in the art.

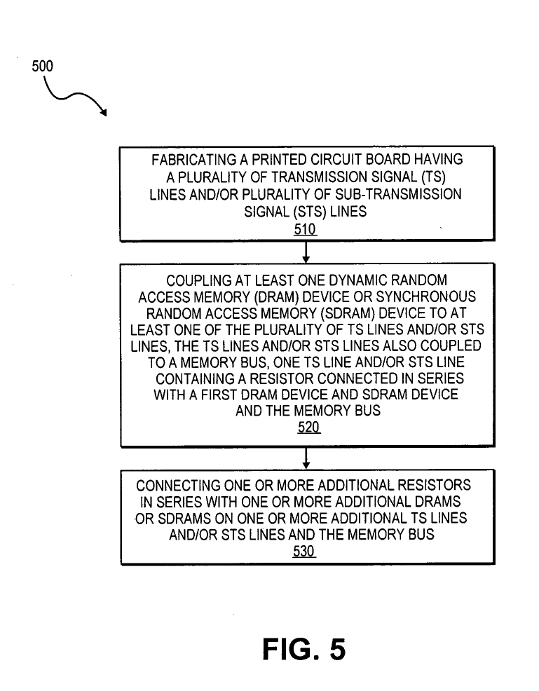

FIG. 5 is a flow diagram of one embodiment of a method to produce the memory modules of FIG. 1, FIG. 2 and FIG. 3. Method 500, in one embodiment, begins by fabricating a PCB containing a plurality of TS lines and/or STS lines (block 510). The TS lines and/or STS lines may form any pattern on the PCB.

In one embodiment, a plurality of DRAM devices or SDRAM devices are connected to the plurality of TS lines and/or STS lines, the TS lines and/or STS lines are also connected to a memory bus, one TS line and/or STS line containing a resistor connected to it and connected to the memory bus in series with a first DRAM device or a first SDRAM device (block 520). Method 500, in one embodiment, also includes connecting at least one additional resistor to a subset of additional TS lines and/or STS lines, similar to the embodiments discussed above, connected in series between the TS lines and/or STS lines and memory bus (block 530).

In the preceding paragraphs, specific embodiments are described. It will, however, be evident that various modifications and changes may be made thereto without departing from the broader spirit and scope of the claims. The specification and drawings are, accordingly, to be regarded in an illustrative rather than a restrictive sense.

1. An apparatus, comprising:
one of a plurality of dynamic random access memory (DRAM) devices and a plurality of synchronous random access memory (SDRAM) devices coupled to a memory bus, each of the one of the DRAM devices and SDRAM devices coupled to the memory bus via at least one of a plurality of transmission signal lines; and
a first resistor coupled to a first transmission signal line coupled to the memory bus, the first resistor in series with one of a first DRAM device and a first SDRAM device.

2. The apparatus of claim 1, wherein the one of the plurality of DRAM devices and the plurality of SDRAM devices are divided into pairs, each pair forming a branch.

3. The apparatus of claim 2, wherein the first resistor is in series with a first branch and the memory bus.

4. The apparatus of claim 3, wherein the first resistor is in the range of about 5 ohms to about 150 ohms.

5. The apparatus of claim 4, wherein the resistor is about 25 ohms.

6. The apparatus of claim 3, wherein a second resistor is in series with a second branch.

7. The apparatus of claim 6, wherein the first resistor and second resistor are a substantially same size.

8. The apparatus of claim 7, wherein the first resistor and the second resistor are each in the range of about 5 ohms to about 150 ohms.

9. The apparatus of claim 6, wherein the first resistor and second resistor are different sizes.

10. The apparatus of claim 9, wherein the first resistor and the second resistor are each in the range of about 5 ohms to about 150 ohms.

11. The apparatus of claim 6, further comprising:
a first plurality of resistors in series with the first branch, the total resistance between the first branch and the memory bus is in the range of about 5 ohms to about 150 ohms, and
a second plurality of resistors in series with the second branch, the total resistance between the second branch and the memory bus is in the range of about 5 ohms to about 150 ohms.

12. The apparatus of claim 2, further comprising:
at least one resistor coupled to each of a plurality of transmission signal lines, each resistor in series with each branch and the memory bus.

13. The apparatus of claim 12, wherein the total resistance between each branch and the memory bus is in the range of about 5 ohms to about 150 ohms.

14. The apparatus of claim 1, wherein each of the one of the plurality DRAM devices and the plurality of SDRAM devices forms a branch, and wherein the resistance on the first transmission signal line is in the range of about 5 ohms to about 150 ohms.

15. The apparatus of claim 14, further comprising:
at least one resistor coupled to each of a plurality of transmission signal lines, each resistor coupled to the memory bus in series with one branch.

16. The apparatus of claim 15, wherein the resistance on each transmission signal line is in the range of about 5 ohms to about 150 ohms.

17. A system, comprising:
a memory package comprising:
one of a plurality of dynamic random access memory (DRAM) devices and a plurality of synchronous random access memory (SDRAM) devices coupled to a memory bus via a plurality of transmission signal lines,
a first resistor coupled to a first transmission signal line, the first resistor in series with one of a first DRAM device and a first SDRAM device and coupled to the memory bus, and
a second resistor coupled to a second transmission signal line, the second resistor in series with one of a second DRAM device and a second SDRAM device and coupled to the memory bus;
a memory controller coupled to the memory package; and
a processor coupled to the memory controller via a system bus.

18. The system of claim 17, wherein the memory package comprises a dual in-line memory module.

19. The system of claim 17, wherein the memory package comprises a single in-line memory module.

20. A method, comprising:
fabricating a printed circuit board (PCB) containing one of a plurality transmission signal (TS) lines and a plurality of sub-transmission signal (STS) lines;
coupling one or more one of a dynamic random access memory (DRAM) device and a synchronous random access memory (SDRAM) device to each of the one of the plurality of TS lines and the plurality of STS lines, each of the one of the plurality of TS lines and the plurality of STS lines also coupled to a memory bus, and one of a first TS line and a first STS line including a first resistor connected in series with one of a first DRAM device and a first SDRAM device and coupled to the memory bus.

21. The method of claim 20, further comprising:
coupling a second resistor in series with one of a second DRAM device and a second SDRAM device on one of a second TS line and a second STS line and coupled to the memory bus.

22. The method of claim 20, further comprising:
coupling at least one resistor in series with one of a respective DRAM device and a respective SDRAM device on each of the one of the plurality of TS lines and the plurality of STS lines, the resistors coupled to the memory bus.
